(19) United States
(12) Patent Application Publication
(10) Pub. No.: US 2021/0337974 A1
(43) Pub. Date: Nov. 4, 2021

(54) Space Saving Sofa Kit

(71) Applicant: Lionel Chen, Rowland Heights, CA (US)

(72) Inventor: Lionel Chen, Rowland Heights, CA (US)

(21) Appl. No.: 16/863,082

(22) Filed: Apr. 30, 2020

(51) Int. Cl. A47C 13/00; A47C 4/02; F16B 12/10; F16B 1/00; A47C 17/04; B65D 85/64

(52) U.S. Cl. CPC A47C 13/005; A47C 4/028; F16B 12/10; F16B 1/00; B65D 2585/647; B65D 85/64; F16B 2012/106; F16B 2001/0028; A47C 17/04

(57) ABSTRACT

This particular invention accomplishes the objective of flat small packing by means of having a flap on the bottom of the sofa base pieces that can fasten and enclose a hollow space inside of the base. Sofa backs, cushions, tools and parts all can be placed inside of the sofa base during storage and shipping inside of a box optimally made of cardboard. The box only needs to be big enough to contain the base piece. The sofa back can then be attached to the seat frame by metal threaded rods. The arms can be attached to the sides using the hardware and the cushions put in place. Supporting legs are screwed onto the bottom by hand and the sofa is complete.

### CROSS-REFERENCE TO RELATED APPLICATIONS

There are no related applications.

### STATEMENT REGARDING FEDERALLY SPONSORED RESEARCH OR DEVELOPMENT

This invention was not made using federally funded research and development. The inventor retains all rights.

### THE NAMES OF THE PARTIES TO A JOINT RESEARCH AGREEMENT

There are no parties to a joint research agreement concerning this invention.

### BACKGROUND OF THE INVENTION

This invention falls within the field of knock down sofa kits which fit within a relatively flat rectangular box so that they may easily be stored in warehouses and transported. Inventive means of enclosing the kit in the smallest, flattest box are desirable because of the need for stable storage using the least amount of space. Further characterization of the relevant field would be that the invention falls in the field of sofa kits that can be readily assembled at home by the end user.

### BRIEF SUMMARY OF THE INVENTION

This particular invention accomplishes the objective of flat small packing by means of having a flap on the bottom of the sofa base pieces that can fasten and enclose a hollow space inside of the base. Sofa backs, cushions, tools and parts all can be placed inside of the sofa base during storage and shipping inside of a box optimally made of cardboard. The box only needs to be big enough to contain the base piece. The sofa back can then be attached to the seat frame by metal threaded rods. The arms can be attached to the sides using the hardware and the cushions put in place. Supporting legs are screwed onto the bottom by hand and the sofa is complete.

### BRIEF DESCRIPTION OF THE SEVERAL VIEWS OF THE DRAWING

FIG. 1 is a perspective view of a hollow furniture base with flap.

FIG. 2 is an exploded view of typical contents of the hollow base.

FIG. 3 is an exploded view of the sofa base showing attachment of the feet.

FIG. 4 is a perspective view of an assembled ottoman.

FIG. 5 is a perspective view of a base containing a cushion, tools, and parts.

FIG. 6 is a perspective view of a chair back showing placement of a metal threaded rod.

FIG. 7 is an exploded view of a chair being assembled.

FIG. 8 is an exploded view of a chair being assembled.

FIG. 9 is a perspective view of an assembled chair.

FIG. 10 is a view of how sofa back and sofa arm are assembled together with a wedge piece.

FIG. 11 is an exploded view of a chair being assembled that has an arm and wedge piece.

FIG. 12 is a perspective view of an assembled chair with arm and wedge piece.

FIG. 13 demonstrates how “n” shaped brackets are used to connect modular components.

FIG. 14 shows one optional completed sofa assembly.

FIG. 15 shows one optional completed sofa assembly.

FIG. 16 shows one optional completed sofa assembly.

FIG. 17 shows one optional completed sofa assembly.

FIG. 18 shows one optional completed sofa assembly.

FIG. 19 shows one optional completed sofa assembly.

### DETAILED DESCRIPTION OF THE INVENTION

This particular invention accomplishes the objective of flat small packing by means of having a flap on the bottom of the sofa base pieces that can fasten and enclose a hollow space inside of the base. Sofa backs, cushions, tools and parts all can be placed inside of the sofa base during storage and shipping inside of a box optimally made of cardboard. The box only needs to be big enough to contain the base piece. The sofa back can then be attached to the seat frame by metal threaded rods. The arms can be attached to the sides using the hardware and then cushions added. Supporting legs are screwed onto the bottom by hand and the sofa is complete.

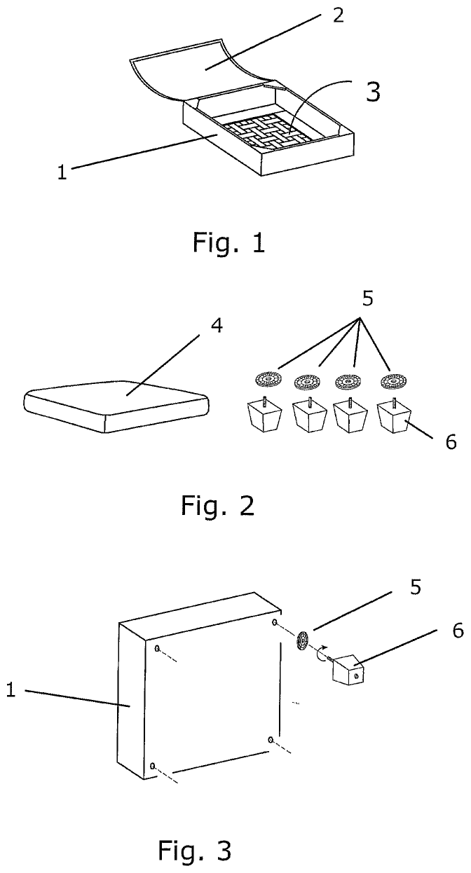

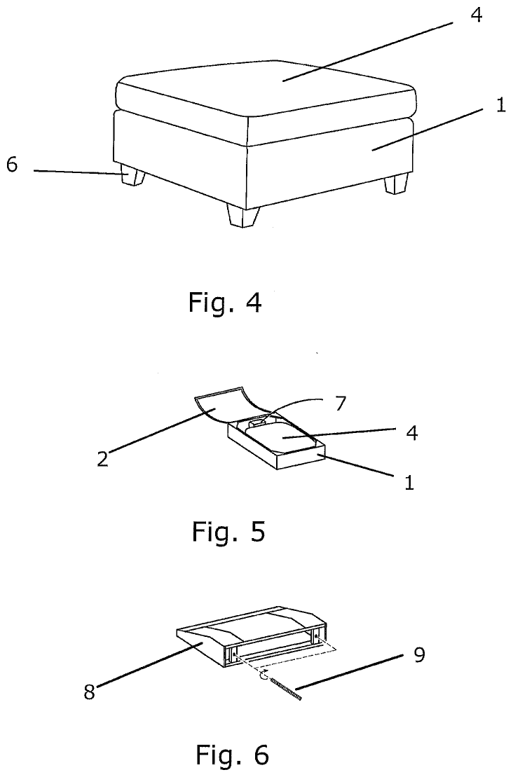

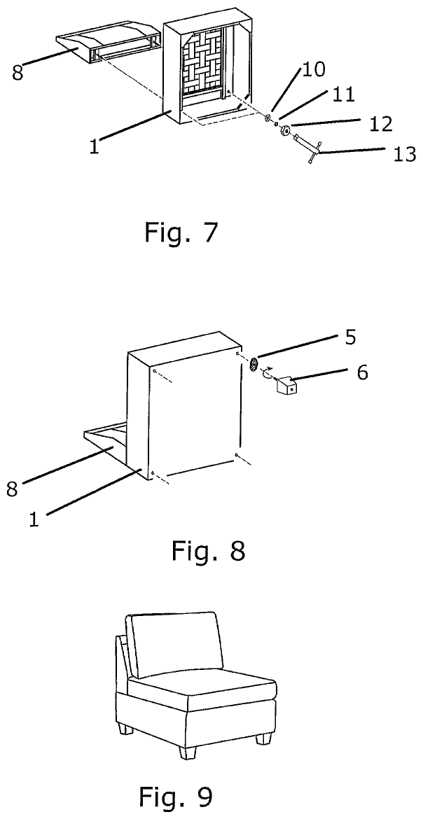

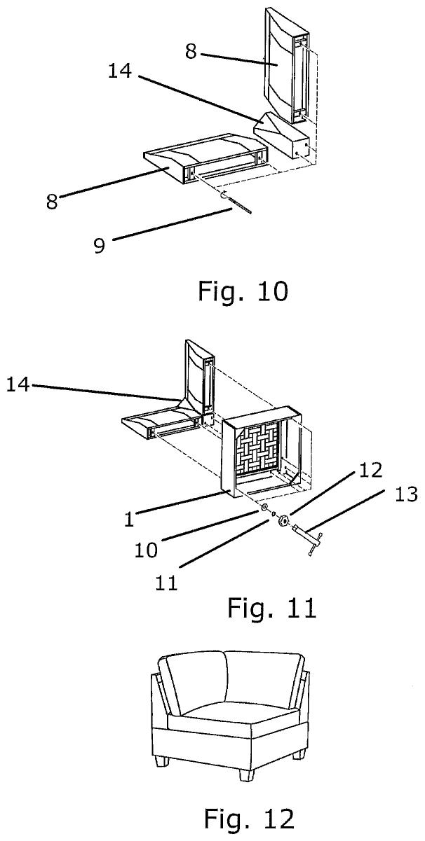

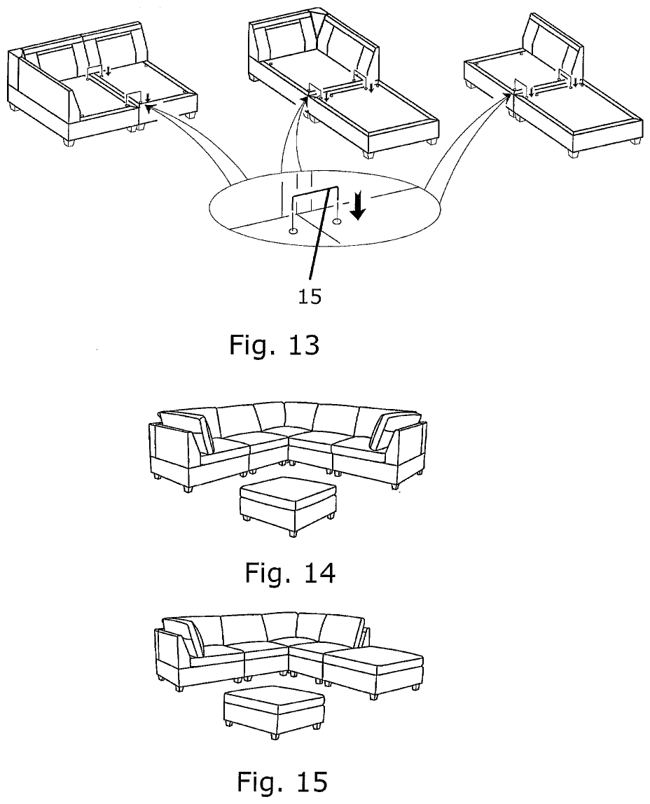

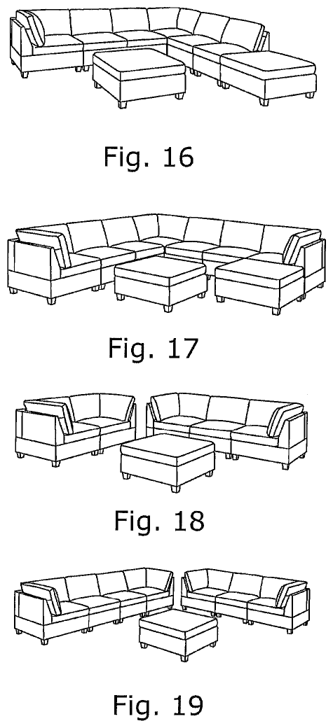

Turning now to FIG. 1 the base piece (1) can be seen with a flap (2) that is adapted to enclose a hollow space (3). In a preferred embodiment, the flap can fasten with hook and loop fastener to enclose the hollow space. In FIG. 2 the seat cushion (4), foot washers (5), and feet (6) can be seen which would be stored in the hollow space (3) in a box containing a module in the ottoman configuration. Turning now to FIG. 3, the manner of attaching the feet (6) with the foot washers (5) to the base piece (1) can be seen. In this figure, the flap located on the bottom of the base piece (1) has been closed after the parts were taken out. Turning now to FIG. 4, an ottoman module is shown in its fully assembled state. Turning now to FIG. 5, a base piece (1) can be seen having a flap (2) with a cushion (4) and a box of tools and parts (7). Turning now to FIG. 6, a chair back (8) can be seen which was also in the hollow space of the base piece seen in FIG. 5 but could not be seen because it was under the cushion. Metal threaded rods (9) are screwed into the chair back (8). FIG. 7 shows a chair back (8) being assembled with a base piece (1) using an assembly washer (10) a lock washer (11) and a nut (12) which are engaged onto the metal threaded rods (9) using the tool (13). FIG. 8 shows a foot (6) and a foot washer (5) being placed onto the bottom of a partially assembled chair module. FIG. 9 shows a fully assembled chair module with the cushions in place. Turning now to FIG. 10, the manner is shown by which one chair back (8) may be joined with another chair back (8) using a wedge piece (14) that forms a back with an arm. Note that the arms (8) and the wedge piece also have bore holes for metal threaded rods (9). The wedge piece (14) can be assembled into the base piece (1) as shown by FIG. 11 using assembly washers (10), lock washers (11), nuts (12) and the tool (13) to engage with the metal threaded rods. Turning now to FIG. 12, a fully assembled corner chair module can be seen with its cushions in place. The backs, cushions, feet, tool, and parts had all be stored inside the base piece while the kit was being shipped in its box. Ottoman modules, chair modules and corner chair modules can all be assembled into more complex furniture configurations. Turning now to FIG. 13, “n” shaped brackets (15) can be used to connect adjacent modules into a more complex configuration. FIGS. 14 through 19 show various complex sofa configurations that can be produced from the three fundamental modules using the “n” shaped brackets.

I claim:

1. A furniture kit comprising a furniture base having a load bearing side and an openable side; said openable side having a fastenable unfastenable flap enclosing a hollow interior; said hollow interior containing parts selected from the group consisting of feet, cushions, washers, nuts, metal threaded rods, chair backs, back corner adapters “n” shaped brackets, and tools.

2. The furniture kit of claim 1 packed in the smallest cardboard box which can contain said furniture base.

3. The furniture kit of claim 1 wherein said flap attaches to said openable side by means of hook and loop fastener.

4. (canceled)

5. (canceled)

6. (canceled)

7. (canceled)

8. (canceled)

9. (canceled)

10. A modular furniture structure comprising a furniture base having a load bearing side and an openable side; said openable side having a fastenable unfastenable flap enclosing a hollow interior; said hollow interior containing parts selected from the group consisting of feet, cushions, washers, nuts, metal threaded rods, chair backs, back corner adapters “n” shaped brackets, and tools; said furniture base and said parts being adapted to assemble into furniture selected from the group consisting of ottomans, chairs, and corner chairs; said “n” shaped brackets usable to connect multiple said modular furniture structures adjacently.
